(19) United States
(12) Patent Application Publication
(10) Pub. No.: US 2005/0196326 A1
(43) Pub. Date: Sep. 8, 2005

(54) Transportable automated onsite extraction apparatus

(75) Inventors: Terri Stripling, Greenfield, NY (US); Jeffrey Wright, Lancaster, PA (US); Jeffrey Karker, Cazenovia, NY (US); Janet Morrison, Simsbury, CT (US)

Correspondence Address: FITZPATRICK CELLA HARPER & SCINTO, 30 ROCKEFELLER PLAZA, NEW YORK, NY, 10112, US

(73) Assignee: DRUGRISK SOLUTIONS

(21) Appl. No.: 10/999,349

(22) Filed: Nov. 30, 2004

Related U.S. Application Data
(60) Provisional application No. 60/526,403, filed on Dec. 1, 2003.

(51) Int. Cl. B01L 3/00

(52) U.S. Cl. 422/99

(57) ABSTRACT

A transportable automated analyte extraction apparatus is provided which includes at least an extraction fluid supply in communication with an extraction chamber, and a collection vessel in communication with the extraction chamber, wherein the extraction chamber includes a sample cartridge. The analyte extraction apparatus preferably utilizes supercritical extraction fluids and a modifying reagent, collectively called the extraction solution, to extract analyte from a sample. The extracted analyte can then be subjected to subsequent testing.

### CROSS REFERENCE TO RELATED APPLICATIONS

This application claims priority under 35 U.S.C. § 119(e) to U.S. Provisional Application No. 60/526,403, filed Dec. 1, 2003.

### BACKGROUND OF THE INVENTION

1. Field of the Invention

The invention relates to a transportable automated extraction apparatus, which can be used on-site for rapidly extracting target substances from a sample, such as analytes from human and animal samples, including keratinous structures like hair and feathers.

The extraction of analytes from samples from humans, animals, fish and other organisms, such as samples of hair, nails, hoofs, feathers, scales, skin and muscle, is desirable for many reasons. For example, the extraction of analytes from human samples can allow for testing of drugs of abuse and steroids. In addition, the extraction of analytes from animal samples can allow for the testing of analytes, such as pesticides, antibiotics, steroids, herbicides, lead, mercury, etc. Still another application is the extraction of environmental contaminants such as polychlorinated biphenyls (PCBs) from media such as soil.

The abuse of drugs in humans has been associated with criminal activities, health problems, newborn addiction, lost worker productivity and high medical costs. Current diagnostic tools for screening for drugs of abuse include methods that look for the presence of drugs or their metabolites in samples of urine, saliva, blood or hair extract. Analysis of urine, blood or saliva has potential problems due to (a) the rapid elimination of drugs of abuse giving a narrow window for testing, (b) the short half life of drugs of abuse in urine, (c) false negative test results due to sample tampering, and (d) false positive test results from cross-reactions with certain medications and foods. Currently the prevailing hair testing procedures are lab-based, cumbersome and time consuming. Such procedures generally cannot easily be performed on-site because they require experienced technicians, chemical handling and controlled environments.

Hair testing, however, provides several advantages over urine, blood or saliva testing. First, it is difficult to evade drug detection with hair analysis because there is a greater time window for drug detection compared to the analysis from alternative sample sources. Following deposition in hair, drugs may persist for extended periods of time and thus may provide information on chronic exposure which may not only replace the need for urinalysis or analysis of blood or saliva, but may also complement them. In addition, hair testing samples may be collected by the person doing the test, substantially reducing the risk of tampering and adulteration.

Current hair testing programs are expensive, requiring laboratory testing with trained personnel.

The object of the present invention is to provide a novel transportable automated apparatus, which allows for the on-site extraction of analytes from multiple samples simultaneously.

### SUMMARY OF THE INVENTION

The present invention relates to a transportable automated on-site apparatus for the rapid extraction of analytes, such as drugs of abuse from a sample. The sample is preferably human or animal hair, but may also be feathers, hooves, nails, skin, muscle, scales, etc. The invention extracts the analyte from the sample using a supercritical extraction fluid, such as carbon dioxide (CO₂), and a modifying reagent which together comprise the extraction solution. The modifying reagent may be any modifying reagent known in the art that is effective for improving the efficiency of extracting analytes. In a preferred embodiment, the modifying reagent may increase the polarity of the extraction fluid, adjust the pH of the extraction fluid, or selectively displace analytes from binding sites in the sample matrix. Nonlimiting examples of modifying reagents include combinations of organic alcohols, organic bases, organic acids, water, or hydrocarbon solvents.

### BRIEF DESCRIPTION OF THE DRAWINGS

Exemplary embodiments of the present invention will now be described in detail with reference to the accompanying figures in which:

FIG. 1 is a schematic representation of an exemplary embodiment of an automated transportable analyte extraction apparatus of the present invention;

FIG.2 is a schematic representation of another exemplary embodiment of an automated transportable analyte extraction apparatus of the present invention;

FIG. 3 is a schematic representation of a further exemplary embodiment of an automated transportable analyte extraction apparatus of the present invention; and

FIG. 4 shows an exemplary embodiment of the extraction chamber and sample cartridge of the automated transportable analyte extraction apparatus shown in FIGS. 1, 2 and 3.

### DETAILED DESCRIPTION OF THE INVENTION

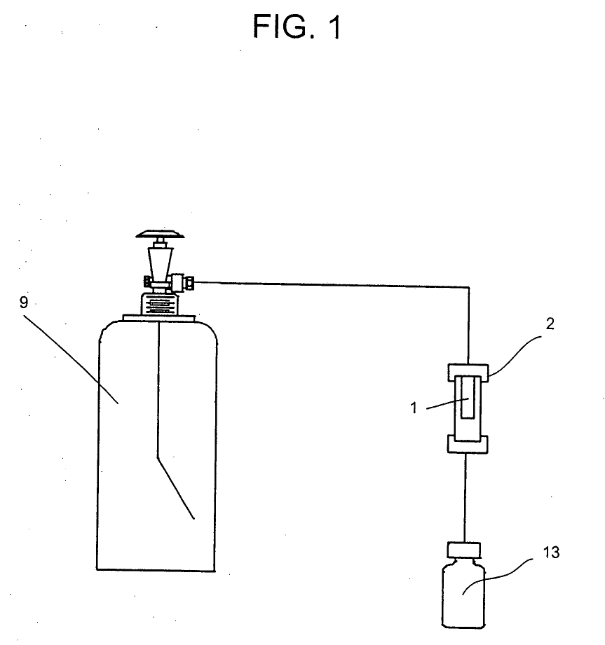

The present invention provides a transportable automated on-site analyte extraction apparatus. The analytes are extracted from a human or animal sample, including, but not limited to, hair, feathers, nails, hooves, fur, skin, muscle, scales, etc. The analytes may alternatively be extracted from a non-animal sample, such as soil. Many analytes of interest may be extracted using the apparatus of the present invention, including, but not limited to, drugs of abuse, antibiotics, steroids, hormones, pesticides, herbicides, mercury, lead, PCBs etc. A preferred embodiment of the invention is depicted in FIGS. 1-3, and the following description of the invention is made with reference to those figures. The invention, however, is not limited by the embodiments shown therein and the skilled artisan will appreciate modifications which may be made staying within the spirit and scope of the invention.

As noted above, the apparatus of the invention extracts analytes from a sample using a pressurized and heated fluid. A non-limiting example of such fluids is a supercritical extraction fluid. As used herein, a supercritical fluid is defined as a fluid which has been pressurized and heated to above its critical pressure and temperature resulting in a fluid with desirable characteristics of both a gas and liquid. In a preferred embodiment, the extraction fluid is CO₂ that is heated and pressurized above its critical temperature and pressure, and which is also known as supercritical CO₂.

Referring to FIG. 1, in one embodiment, the apparatus of the present invention is an automated, transportable apparatus comprising an extraction fluid supply 9, in communication with an extraction chamber 2 which includes a sample cartridge 1, and a collection vessel 13 in communication with the extraction chamber. The extraction fluid is moved from the extraction fluid supply 9 through the apparatus to effectuate extraction of a sample in the sample chamber. The movement of the extraction fluid may be accomplished by any means known in the art, including, but not limited to, pressurization and by a pump.

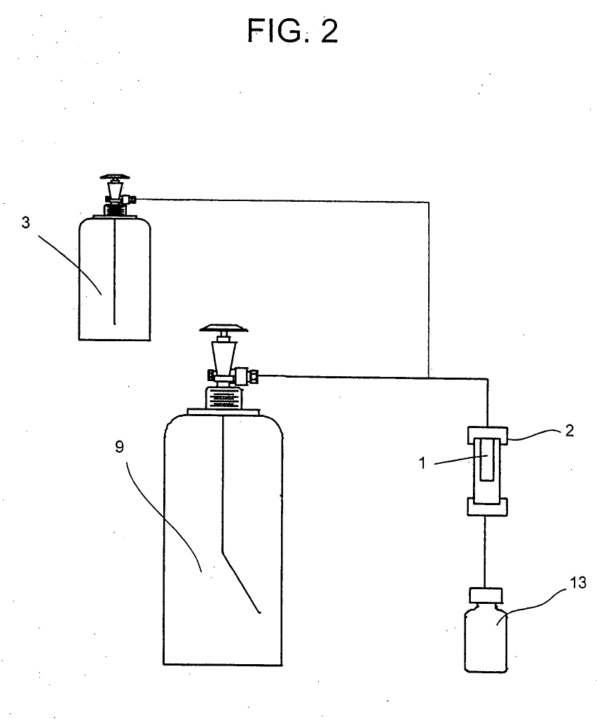

Referring to FIG. 2, in another embodiment, the apparatus of the present invention further comprises a modifying reagent supply 3. A modifying reagent can improve extraction of an analyte from the sample and is further described infra.

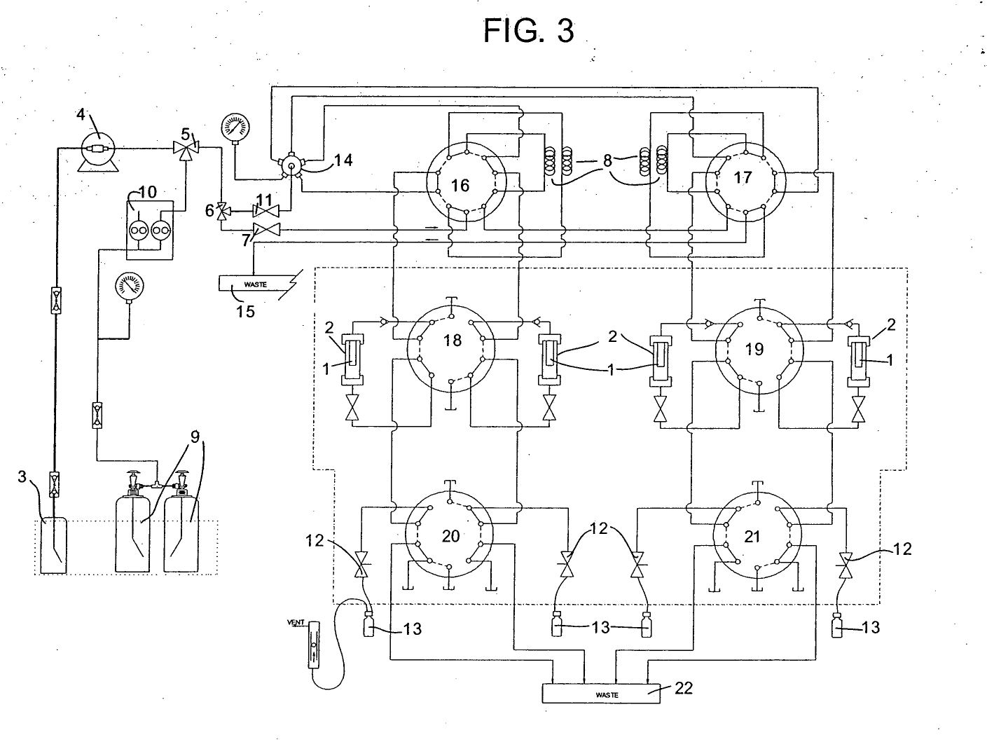

Referring to FIG. 3, in a preferred embodiment, a source of compressed gaseous extraction fluid, shown as a pressurized cylinder 9, which may also be provided as an air compressor, is connected to a port upstream of the extraction chamber 2. One possible connection is to the multi-port valve position 14. The flow of gas is initiated through the restrictor valves and tubing, into the sample

Again referring to FIG. 3, in a preferred embodiment of the invention, a sample, e.g. hair, is collected from a specimen (e.g. a human) by any means known in the art, such as by plucking, cutting, powdering of the hair with a razor, etc. The sample is then placed into the sample cartridge 1 of the invention. A plurality of sample cartridges may be included in the apparatus of the invention. In a preferred embodiment, the apparatus of the invention comprises multiple sample cartridges and can therefore process multiple different samples at the same time. The samples may be from the same or a different specimen. In the embodiment illustrated in FIG. 3, the apparatus of the present invention comprises up to four parallel extraction paths using as many as four respective cartridges 1 and as many as four extraction chambers 2.

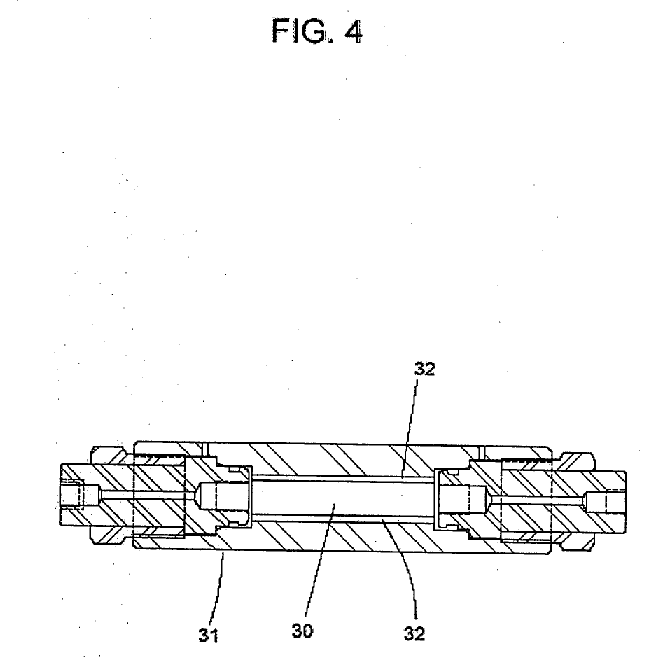

The sample cartridges are configured such that the sample is accessible for analyte extraction. The sample cartridge is preferably a cylindrical shape and may have an inlet and outlet side. In one embodiment, the sample cartridge may have frits or micro filters on the inlet and outlet sides. The sample cartridge 1 is then placed into the extraction chamber 2 of the apparatus of the present invention. The extraction chamber 2 of the apparatus is further shown in FIG. 4.

Referring to FIG. 4, the outer diameter of the sample cartridge 30 and inner diameter of the extraction chamber 31 are preferably designed to leave a small volume of open space 32 between the outer sample cartridge wall and inner extraction chamber wall at the extraction conditions (temperature and pressure). In one embodiment, the extraction solution (such as the supercritical extraction fluid and modifying reagent) fills the open space between cartridge and chamber walls, minimizing the pressure differential across the sample chamber wall. All closures on the sample cartridges and extraction chambers are preferably gently tightened by hand, i.e., finger-tightened. In a preferred embodiment of the invention, the extraction chambers are multi-use (permanent), high-pressure vessels made of metal, and the sample cartridges are single-use, disposable vessels, preferably made of plastic. Nonlimiting examples of disposable sample cartridges are described in U.S. Provisional Patent Application Ser. No. 60/526,404, filed on Dec. 1, 2003, the disclosure of which is incorporated herein by reference in its entirety. A non-disposable sample cartridge suitable for use in the present invention is described in U.S. Pat. No. 6,478,750, the disclosure of which is incorporated herein in its entirety. Some samples or matrices will require pre-washing of the specimen prior to extraction. For example, when testing for drugs of abuse, external environmental contamination must be distinguished from metabolized analytes.

By washing the specimen prior to extraction, the environmental contaminants are removed. A non-limiting example of a wash solution is pure sub-critical fluid such as CO₂. In a preferred embodiment, with reference to FIG. 3, such a washing fluid would be routed from the fluid supply 9 into the sample cartridge 1. In a preferred embodiment, the fluid is pumped via a liquid and/or gas and or/ CO₂ pump 10, through a three way valve 5, through a diverter 6 and through an extract valve 11 and a multiport valve 14 and ultimately into the extraction chamber 2. The wash fluid flows through the extraction chamber 2, with flow routed to a waste tray 15.

Again, with reference to FIG. 3, the apparatus further may comprise a modifying reagent supply 3. The modifying reagent may be any modifying reagent known in the art that is useful for improving efficiency of the extraction of analytes from samples, such as, reagents that increase the polarity of supercritical extraction fluid. Nonlimiting examples of such modifying reagents include combinations of organic alcohols, organic bases, organic acids, water, or hydrocarbon solvents. In a particularly preferred embodiment, the modifying reagent is a mixture of methanol (MeOH), triethylamine (TEA), and water, in a 2:2:1 v/v % ratio.

The modifying reagent is delivered from the supply 3, via modifier pump 4, through the three way valve 5 through the diverter 6 and sample valve 7, through multiport valves 16 and/or 17 to a sample loop 8, where it resides until the supercritical extraction fluid passes through the sample loop 8 and combines with the modifying reagent en route to the extraction chamber 2. Additional multiport valves can be included 18 and 19 to deliver the supercritical extraction fluid to a plurality of extraction chambers 2.

The three-way valve 5 is a selector switch which, depending on its position, routes either the primary extraction fluid from the CO₂ pump 10 or the modifying reagent from modifier pump 4 through this system at any given time. The diverter 6 directs flow either to (a) the sample valve 7 which directs fluid through the multiport valves 16 and/or 17 to the sample loop 8 or (b) the extract valve 11 which directs fluid through the multiport valve 14 and then through multiport valves 16 and/or 17 and ultimately to the extraction chamber 2. The sample loop 8 ensures that a desired volume of modifying reagent is used. In alternative embodiments, only a single pump is required to deliver both supercritical fluid and modifying reagent. While the inclusion of modifying reagent represents a preferred embodiment of the invention, the pure extraction fluid may be used in the absence of modifying reagents for some applications.

Referring again to FIG. 3, in a preferred embodiment, after the sample cartridge 1 is placed into the extraction chamber 2 and the sample loop 8 is loaded with modifying reagent, extraction fluid is directed from the supply 9 through the apparatus and pressurized by the high pressure pump 10. In a preferred embodiment, a pump capable of achieving the required pressures uses Peltier cooling and is available from Scientific Systems International (Tulsa, Okla.). In another embodiment, a conventional pump and an external cooling source may be used in the absence of mechanical pumping. In a further embodiment highly pressurized extraction fluid may be used. The dotted lines in FIG. 3 show an area within which heat may be supplied. After leaving the high pressure pump, extraction fluid is diverted via diverter 6 through extract valve 11.

Upon exiting extract valve 11, the extraction fluid passes through tubing and valves within the heated region designated by dotted lines in FIG. 3, elevating the temperature and pressure above the critical points at which the extraction fluid reaches the supercritical state, i.e. embodying characteristics of both a gas and liquid. Supercritical fluids are preferred for extracting analytes from the sample because while liquids have high solvating power, they are not very diffuse and are not capable of accessing all binding sites within a dense matrix. Conversely, while gases are very diffuse, they have relatively low solvating power. Supercritical fluids are diffuse like gases and possess a solvating power approaching that of liquids which make them effective for extraction.

When the supercritical extraction fluid is directed through the sample loop 8 containing the modifying reagent, a supercritical extraction solution is produced, which passes through the extraction chamber 2, where the modifying reagent and extraction fluid mix with the sample. The extraction fluid and modifying reagent, together called the extraction solution, extracts the analyte from the sample therein. In addition, a static extraction, or incubation period, may be required in which the mixture is contained in the sample cartridge and extraction chamber for a period of time without dynamic flow. For many samples, the supercritical extraction solution, which includes the modifying reagent, is capable of extracting more analytes from the sample than the pure supercritical fluid alone. For example, by increasing the polarity of the pure supercritical extraction fluid with a polar reagent, such as MeOH or water, polar analytes can be extracted. On the other hand, including a basic modifying reagent may facilitate selective displacement of an analyte from a matrix binding site.

In other embodiments of the invention, a liquid pump may be used to deliver modifier in metered amounts, or a single pump may be used to deliver the extraction fluid and meter the modifying reagent through the apparatus thus eliminating the need for the sample loop.

After the analyte has been extracted from the sample the supercritical extraction solution, comprising extracted analytes, is routed from the extraction chamber 2 and into the collection vessel 13 via a restrictor such as a restricting micro-metering valve 12, through which depressurization takes place. Depressurization may be effectuated by a depressurization mechanism, such as, but not limited to, the shown restricting metering valve 12, a tube with small inner-diameter, or instrumentation such as an automated feed-back controlled metering valve. During depressurization, the supercritical extraction fluid changes from its supercritical state to a gaseous state. The analyte is captured during or just following the depressurization in a collection vessel 13, allowing the extraction fluid to escape to the atmosphere as a gas. The restrictor valve or tubing or collection vessel may be heated to avoid freezing due to the rapid depressurization of the extraction fluid. The collection vessel may capture the analyte in solid or liquid phase. For example, the collection vessel may contain a trapping solvent, such as methanol, which captures the analyte in a liquid phase. Alternatively, the collection vessel may contain a solid phase, such as a packed bed or filter paper having an affinity for the analyte thereby facilitating capture of the analyte. Additional multiport valves 20 and 21 may be included to direct the fluid passing through the apparatus to various end points, such as to the collection vessel, if the fluid includes an analyte of interest, or to a waste tray 22, if desired, for example when washing the apparatus with a wash fluid.

After the analyte has been captured in the collection vessel, it may be retrieved by any means known in the art, such as elution, or washing, or may remain in its trapped form. The analyte may be tested by any means known in the art. For example, an analyte detection element may be used to determine the presence of extracted analyte. In a preferred embodiment, the analyte detection element is selected from the group consisting of a detection card, antibody-based assays, such as ELISAs, and antibody-based detection instruments.

The extraction apparatus may also include an evaporation means to concentrate the extracted analyte. Volatile liquid substances, such as the trapping solvent, may be evaporated by the addition of heat. In one embodiment, the evaporation means is a stream of heated gas, such as air or nitrogen. Removing the volatile substances may result in an improvement in detection sensitivity, if, for example, the volatile substances are not compatible with detection formats such as antibody-based ELISAs. This allows for the integration of a detection function using readily available antibody-based assays and antibody-based assay detection instruments in an on-site automated transportable apparatus.

To effectively remove nearly all the extracted analyte from the apparatus tubing and instrumentation, into the collection vessel, a rinse of the restrictor valve and tubing may be required. A direct route may be provided through which the flushing reagent will be charged into the apparatus, through the restrictor valve and tubing, into the collection vessel.

The extraction apparatus, as disclosed herein, may be automated and may include, for example, a menu-driven control system. In one embodiment, once the samples are loaded, the operator can select a process menu method and initiate an automatic process cycle. Examples of automatic process cycles may include, but not be limited to, extraction of drugs of abuse from hair, antibiotics from hooves, and PCBs from sediment. The selection from the apparatus menu controls process variables such as, but not limited, flow path, temperature, pressure, incubation period, modifier quantity, time of dynamic flow through the sample, washing the sample prior to extraction or washing the fluid flow path after extraction, etc. that have been optimized for that specific extraction process. The multiport valves of the present invention 14, 16, 17, 18, 19, 20 and 21 are controlled by the menu-driven control system to effectuate different process menus. For example, depending on the path through which the fluid enters the valve and the state of valve actuation (actuated or de-actuated), the fluid entering the multi-port valves can flow into the samples or bypass the samples. Downstream of the samples, the fluid can be routed by multi-port valves into a waste container or the sample restrictor. The multiple entry-ports of the multi-port valves enable multiple fluids to be routed into the system as previously stated. In a preferred embodiment of the invention, an extraction fluid, a modifying solution and multiple wash solutions can be routed into the samples or around the samples to waste or a sample restrictor. The addition of a menu driven control system greatly enhances the versatility of the apparatus as well as optimizes the performance and repeatability. The programmable capability of the apparatus enables use by non-technical operators.

1. An automated transportable analyte extraction apparatus comprising
(a) an extraction fluid supply,
(b) an extraction chamber in communication with the extraction fluid supply wherein said chamber includes a sample cartridge, and
(c) a collection vessel in communication with the extraction chamber.

2. The automated transportable analyte extraction apparatus according to claim 1, further comprising a plurality of sample cartridges, a plurality of extraction fluid supplies, a plurality of extraction chambers and a plurality of collection vessels.

3. The automated transportable analyte apparatus according to claims 1 or 2, further comprising a modifying reagent supply.

4. The automated transportable analyte extraction apparatus according to claims 1 or 2, further comprising at least one multiport valve, and wherein the multiport valve aids in the automation of the apparatus.

5. The automated transportable analyte extraction apparatus according to claim 3, further comprising a sample loop, wherein extraction fluid combines with modifying reagent prior to communication with the extraction chamber.

6. The automated transportable analyte extraction apparatus according to claims 1 or 2, further comprising a pump in communication with the extraction fluid supply, wherein the pump delivers the extraction fluid to the extraction chamber.

7. The automated transportable analyte extraction apparatus according to claim 6, further comprising a heating supply, and wherein the pump and heating supply elevate the pressure and temperature above a critical point to provide supercritical extraction fluid.

8. The automated transportable analyte extraction apparatus according to claims 1 or 2, further comprising a restrictor, wherein the restrictor depressurizes the supercritical extraction fluid to create a gaseous extraction fluid comprising extracted analyte.

9. The automated transportable analyte extraction apparatus according to claims 1 or 2, further comprising a control system.

10. The automated transportable analyte extraction apparatus according to claim 9, further comprising at least one multiport valve and wherein the multiport valve is controlled by the control system.

11. The automated transportable analyte extraction apparatus according to claims 1 or 2, further comprising an analyte detection element.

12. The automated transportable analyte extraction apparatus according to claim 11, wherein the analyte detection element includes an antibody-based assay.
